(19) United States
(12) Patent Application Publication
(10) Pub. No.: US 2016/0127857 A1
(43) Pub. Date: May 5, 2016

(54) ENHANCED INTEROPERABILITY BETWEEN HOST CARD EMULATION AND A SECURE ELEMENT

(71) Applicant: QUALCOMM Incorporated, San Diego, CA (US)

(72) Inventors: Jeremy Robin Christopher O'DONOGHUE, Wokingham (GB); Pierre-Francois APPIETTO, Woking (GB); Manmohan Jhabar RAWAT, Farnborough (GB); Dubai CHINGALANDE, Farnborough (GB); Umesh JAGGA, Camberley (GB)

(21) Appl. No.: 14/669,962

(22) Filed: Mar. 26, 2015

Related U.S. Application Data
(60) Provisional application No. 62/072,912, filed on Oct. 30, 2014.

(51) Int. Cl. H04W 4/00; H04B 5/00; H04W 76/02

(52) U.S. Cl. CPC H04W 4/008; H04W 76/023; H04B 5/0031

(57) ABSTRACT

Various aspects are described herein in connection with a method and/or apparatus of near-field communication (NFC). For example, various methods and apparatuses include an NFC controller receiving a message from a remote NFC device specifying a radio frequency (RF) technology for communication. The methods and apparatuses also include the NFC controller determining whether the specified RF technology matches a preferred RF technology for an application. The methods and apparatuses also include the NFC controller establishing NFC communications with the remote NFC device only when the specified RF technology matches the preferred RF technology of the application, wherein the NFC communications are established using the established RF technology. In an aspect, the methods and apparatuses include the NFC controller performing a card emulation operation, such as host-based card emulation (HCE).

### CROSS-REFERENCE TO RELATED APPLICATION

This application claims the benefit of U.S. Provisional Application Ser. No. 62/072,912, entitled, “Enhanced Interoperability Between Host Card Emulation and a Secure Element,” and filed on Oct. 30, 2014, which is expressly incorporated by reference herein in its entirety.

### BACKGROUND

The present disclosure relates generally to communications between and/or within devices, and specifically to near-field communications (NFC).

Advances in technology have resulted in smaller and more powerful personal computing devices. For example, there currently exist a wide variety of portable personal computing devices, including wireless computing devices like portable wireless telephones, personal digital assistants (PDAs), and paging devices, that are each small, lightweight, and can be easily carried by users. More specifically, the portable wireless telephones further include, for example, cellular telephones that communicate voice and data packets over wireless networks. Many such cellular telephones are manufactured with ever-increasing computing capabilities, and as such, are themselves becoming tantamount to small personal computers and hand-held PDAs. Further, such devices enable communications using a variety of frequencies and applicable coverage areas, such as cellular communications, wireless local area network (WLAN) communications, near-field communication (NFC), etc.

In some NFC devices, ineffective and/or inefficient operation or utilization of card emulation platforms (e.g., secure element-based and host-based) may occur, especially when more than one platform is installed in a single device. Even more, the foregoing ineffective and/or inefficient operation may inhibit a user equipment equipped with an NFC device from full use of an array of applications based on different emulation platforms included in the device. Thus, improvements in NFC operations may be desired.

### SUMMARY

The following presents a summary of one or more aspects to provide a basic understanding of such aspects. This summary is not an extensive overview of all contemplated aspects, and is not intended to identify key or critical elements of all aspects nor delineate the scope of any or all aspects. Its purpose is to present some concepts of one or more aspects form as a prelude to the more detailed description presented later.

Various aspects are described herein in connection with a method and/or apparatus of near-field communication (NFC). For example, various methods include an NFC controller receiving a message from a remote NFC device specifying a radio frequency (RF) technology for communication. The methods also include the NFC controller determining whether the specified RF technology matches a preferred RF technology for an application. The methods also include the NFC controller establishing NFC communications with the remote NFC device only when the specified RF technology matches the preferred RF technology of the application, wherein the NFC communications are established using the established RF technology.

In an aspect, an apparatus for controlling NFC is provided. For example, the apparatus can include means for receiving a message from a remote NFC device specifying a radio frequency (RF) technology for communication. The apparatus also includes means for determining whether the specified RF technology matches a preferred RF technology for an application. The apparatus also includes means for establishing NFC communications with the remote NFC device only when the specified RF technology matches the preferred RF technology of the application, wherein the NFC communications are established using the specified RF technology.

In an aspect, a non-transitory computer-readable medium storing computer-executable code for controlling NFC is provided. For example, the computer-readable medium can include code for receiving a message from a remote NFC device specifying a radio frequency (RF) technology for communication. The computer-readable medium also includes code for determining whether the specified RF technology matches a preferred RF technology for an application. The computer-readable medium also includes code for establishing NFC communications with the remote NFC device only when the specified RF technology matches the preferred RF technology of the application, wherein the NFC communications are established using the specified RF technology.

In an aspect, an apparatus for NFC is provided. For example, the apparatus can include an NFC controller. In an aspect, the NFC controller is configured to receive a message from a remote NFC device specifying a radio frequency (RF) technology for communication. The NFC controller is also configured to determine whether the specified RF technology matches a preferred RF technology for an application. The NFC controller is also configured to establish NFC communications with the remote NFC device only when the specified RF technology matches the preferred RF technology of the application, wherein the NFC communications are established using the specified RF technology.

To accomplish the foregoing and related ends, the one or more aspects comprise features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, where dashed lines may indicate optional elements or actions, and in which:

FIG. 1 is a block diagram of a wireless communication system in accordance with an aspect of the present disclosure.

FIG. 2 is a schematic diagram of a wireless communication system in accordance with an aspect of the present disclosure.

FIG. 3 is a block diagram of an NFC environment in accordance with an aspect of the present disclosure;

FIG. 4 is a signaling diagram of an NFC environment in accordance with an aspect of the present disclosure; and

FIG. 5 is a flowchart describing an aspect of card emulation in accordance with an aspect of the present disclosure.

FIG. 6 is a block diagram of another NFC environment in accordance with an aspect of the present disclosure;

FIG. 7 is a functional block diagram example architecture of a communications device in accordance with an aspect of the present disclosure;

### DETAILED DESCRIPTION

Various aspects are now described with reference to the drawings. In the following description, for purposes of explanation, numerous specific details are set forth to provide a thorough understanding of one or more aspects. It should be understood, however, that such aspect(s) can be practiced without these specific details.

The present aspects generally relate to determining an RF technology to enable communications for host card emulation (HCE). Specifically, an NFC device can operate according one of a plurality of available RF technologies. An NFC device can operate in a reader/writer mode, a peer-to-peer mode, and a card emulation mode. In the reader/writer mode, the NFC device emits an electromagnetic field that powers a passive transponder/tag. Operating in this mode, the NFC device can read and alter data stored in NFC-compliant passive (e.g., without battery) transponders/tags. Such tags can permit the retrieval of additional information by reading the tag with the NFC device. The peer-to-peer mode (e.g., ISO 18092) can permit two NFC devices to establish a bidirectional connection to exchange data. In the card emulation mode, an NFC device can act as or perform functions similar to a smart card (e.g., ISO 14443). The emulated smart card can then be accessed by an external NFC reader, such as, but not limited to, an NFC point-of-sale terminal.

Specifically, in an aspect, an NFC device can include a card emulation mode in which the NFC controller can determine whether a message having a specified RF technology received from a remote NFC device (e.g., a reader) matches a preferred RF technology for a corresponding application. As such, the NFC controller can thereby ensure an NFC communication with the remote NFC device is established only when the specified RF technology matches the preferred RF technology of the application. As such, in an aspect, the present apparatus and methods may dynamically ensure that both host-specific and secure element-specific NFC applications will be properly selected, regardless of the polling configuration of the remote NFC device.

Aspects of the present disclosure are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described herein are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

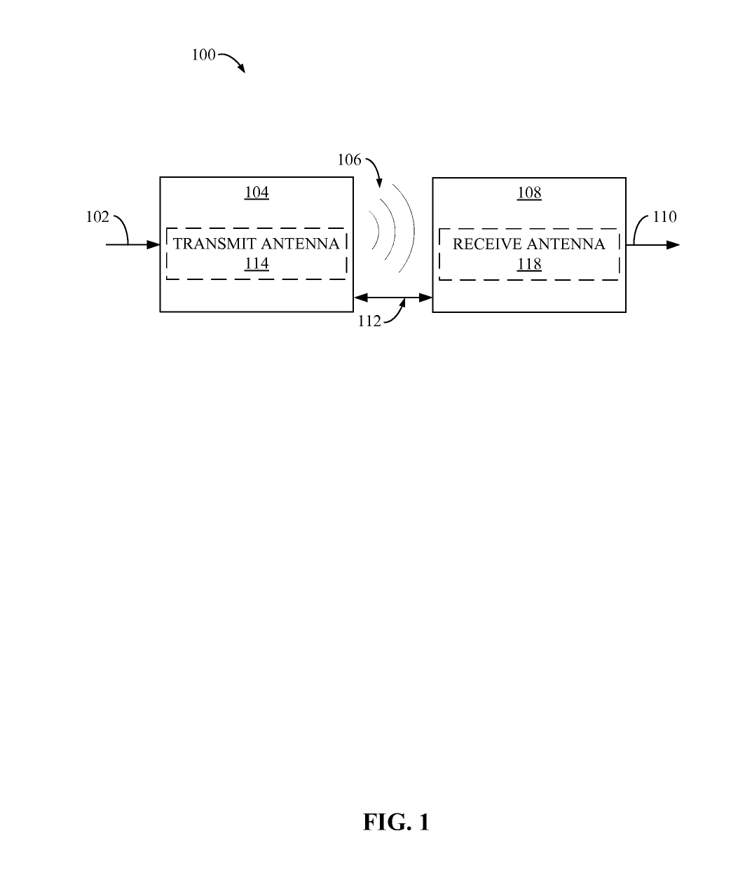

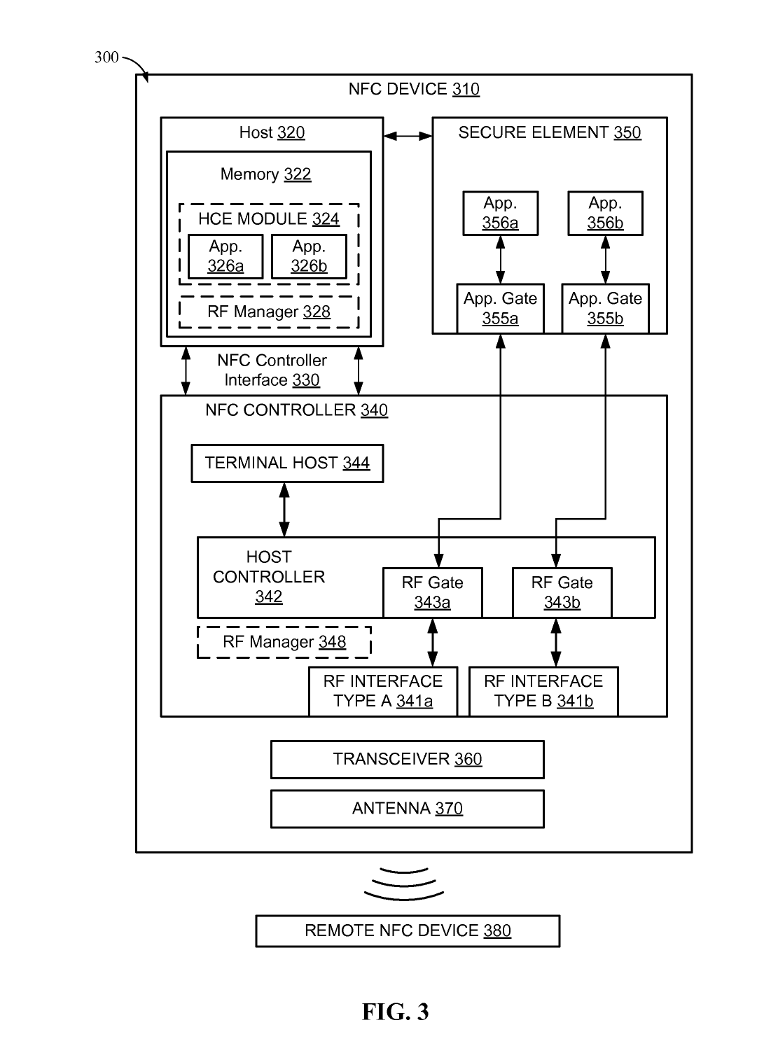

FIG. 1 illustrates a wireless transmission or charging system 100, in accordance with various aspects described herein. In some aspects, transmitter 104 can be included as part of NFC device 310 (see FIG. 3). Specifically, for example, transmitter 104 can form or otherwise be part of transceiver 360 (FIG. 3). Additionally, transmit antenna 114 can form or otherwise be part of antenna 370 (FIG. 3). Input power 102 is provided to transmitter 104 for generating a radiated inductive field 106 for providing energy transfer. Receiver 108 couples to radiated inductive field 106 and generates an output power 110 for storage or consumption by a device coupled to output power 110. Both transmitter 104 and receiver 108 are separated by a distance 112, which is also referred to herein as an operating volume (OV). In one example, transmitter 104 and receiver 108 are configured according to a mutual resonant relationship and when the resonant frequency of receiver 108 and the resonant frequency of transmitter 104 are within a threshold OV, transmission losses between transmitter 104 and receiver 108 are minimal (e.g., when receiver 108 is located in the “near-field” of the radiated inductive field 106).

Transmitter 104 can include a transmit antenna 114 for transmitting energy and signals. A receiver 108 can include a receive antenna 118 for receiving signal and energy, if needed. Transmit antenna 114 and receive antenna 118 can be sized according to applications and devices associated therewith. As stated, an efficient energy transfer can occur by coupling a large portion of the energy in the near-field of the transmitting antenna 114 to a receiving antenna 118 rather than propagating most of the energy in an electromagnetic wave to a far field. When in this near-field, a coupling mode can be developed between transmit antenna 114 and receive antenna 118. The area around antennas 114 and 118 where this near-field coupling can occur is referred to herein as a “coupling-mode region”.

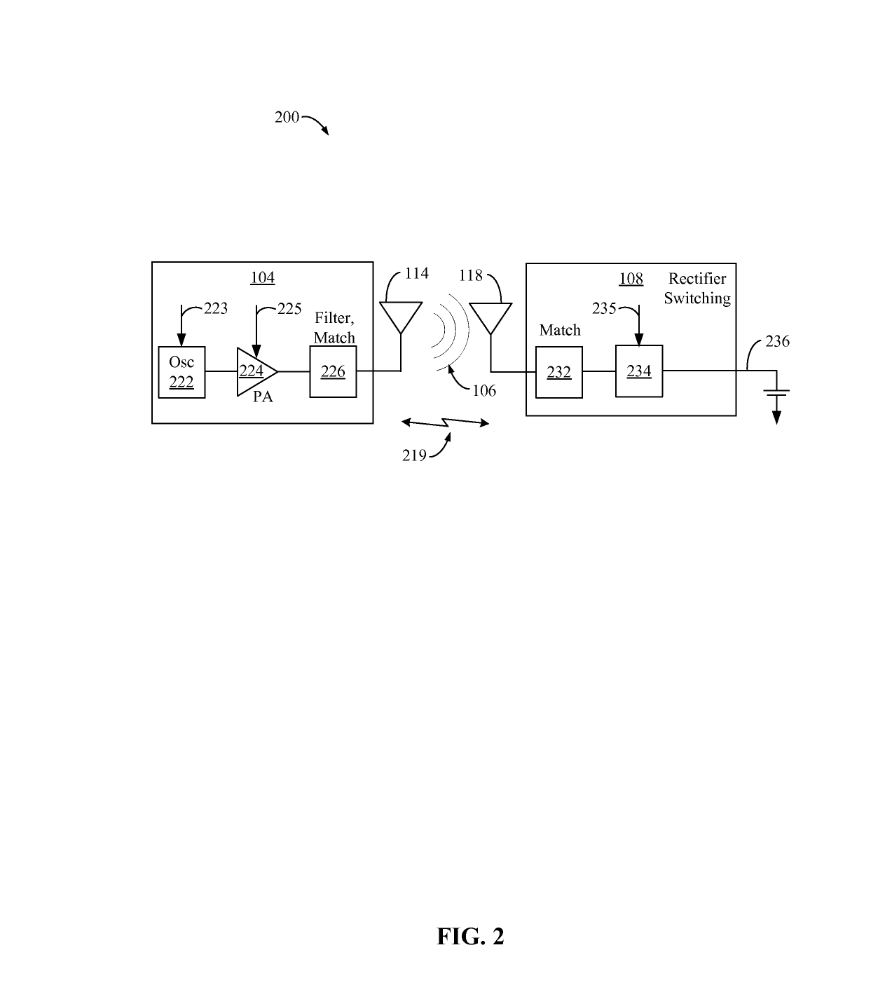

FIG. 2 is a schematic diagram of an example near-field wireless communication system 200, in accordance with various aspects described herein. Transmitter 104 includes an oscillator 222, a power amplifier 224 and a filter and matching circuit 226. In some aspects, transmitter 104 can be included as part of NFC device 310 (see FIG. 3). Specifically, for example, transmitter 104 can form or otherwise be part of transceiver 360 (FIG. 3). Additionally, transmit antenna 114 can form or otherwise be part of antenna 370 (FIG. 3). Oscillator 222 can be configured to generate a signal at a desired frequency, which can be adjusted in response to adjustment signal 223. The oscillator signal can be amplified by power amplifier 224 with an amplification amount responsive to control signal 225. Filter and matching circuit 226 can be included to filter out harmonics or other unwanted frequencies and match the impedance of transmitter 104 to transmit antenna 114.

Receiver 108 can include a matching circuit 232 and a rectifier and switching circuit 234 to generate a DC power output to charge a battery 236 as shown in FIG. 2, or power a device coupled to the receiver, though it is to be appreciated that devices may each have batteries (e.g., in peer-to-peer communications) such that powering by magnetic field may not be needed. Matching circuit 232 can be included to match the impedance of receiver 108 to receive antenna 118. In an aspect, rectifier and switching circuit 234 can be modified by a control signal 235. Receiver 108 and transmitter 104 can communicate on a separate communication channel 219 (e.g., BLUETOOTH® (BT or Bluetooth), WiFi, zigbee, cellular, etc), in one example. In some aspects, receiver 108 can be included as part of NFC device 310 (see FIG. 3). Specifically, for example, receiver 108 can form or otherwise be part of transceiver 360 (FIG. 3).

FIG. 3 is a block diagram of an NFC environment 300, in accordance with an aspect of the present disclosure, in which an NFC device 310 includes RF managers 328, 348 for controlling a type of NFC communications exchanged with a remote NFC device 380. NFC device 310 can include transceiver 360 and antenna 370, each of which can be configured to facilitate communication with remote NFC device 380 using NFC. For example, remote NFC device 380 can correspond to a reader, card, or tag, which can connect wirelessly over an NFC radio interface to NFC device 310. In an aspect, NFC device 310 can, via operation of NFC controller 340 and at least one RF manager 328, 348, be configured to use a card emulation platform, e.g., via secure element 350 or host 320, based on the type of message sent by remote NFC device 380 and the application specified for card emulation. In other words, when remote NFC device 380 operating as a reader alternates polling NFC device 310 using different NFC types, NFC controller 340 and at least one RF manager 328, 348 control a response to the respective polls to dynamically ensure that both host-based and secure element-based NFC applications will be properly selected, regardless of the polling configuration of the reader.

In an aspect, the card emulation mode can be implemented with or without the presence of the host, yet can operate in conjunction with secure element 350 connected to NFC controller 340 of NFC device 310. In an aspect, for example, secure element 350 can include or otherwise take the form of, but is not limited to, a universal integrated circuit card (UICC) or an embedded secure element. In another aspect, the card emulation mode can be implemented without secure element 350.

In an aspect, host 320 can be a processor or central processing unit (CPU) configured to provide an emulated card via host-based card emulation (HCE) to NFC controller 340. In an aspect, host 320 can be or otherwise take the form of an execution environment responsible for the emulating a card without the use of secure element 350. In some implementations, this may also include the management (e.g., initialization, configuration, power management, etc.) of NFC controller 340. Host 320 can communicate with the contactless front-end (CLF) included in NFC controller 340 via an NFC controller interface (NCI) 330. In an aspect, NCI 330 can include multiple gates that serve as entry points towards specific services that are operated inside host 320 or NFC controller 340. In an aspect, host 320 includes RF manager 328 that can provide instructions for host 320 to configure the preferred type of radio frequency (RF) technology to be used for card emulation for host-based or secure element applications.

NFC controller 340 can be configured to be a contactless front-end (CLF) and act as the logical entity responsible for the transmission of data over the NFC radio interface. In an aspect, NFC controller 340 includes RF manager 348 that is configured to determine the preferred type of radio frequency (RF) technology to be used for card emulation for host-based or secure element-based applications, and configure gates and modules within NFC controller 340 to perform card emulation based on an identified application. In an aspect, RF manager 328 in host 320 and RF manager 348 in NFC controller 340 can operate co-operatively to optimize the configuration of NFC device 310. As such, in an aspect, NFC controller 340 can have a connection to device host 320 and/or secure element 350.

RF interfaces 341a, 341b are connections between host controller 340 and transceiver 360 that enable communications with remote NFC device 380 in accordance with different NFC communication types or protocols. As such, each RF interface 341a, 341b may be associated with a different RF interface type and can thereby configure transceiver 360 and/or antenna 370 using a specified RF modulation scheme. In an aspect, the specified RF modulation scheme can be in accordance with a scheme as specified in ISO 14443. For example, RF interface type A 341a can configure transceiver 360 to operate at a 106 kbit speed and use Manchester Coding, while RF interface type B 341b can operate at a 106 kbit speed and use non-return-to-zero (NRZ) Coding. Other codings and bit rates are also possible in other configurations (e.g., type A can operate at 212 kbit/s). In an aspect, NFC controller 340 can be configured to only enable one RF interface 341a, 341b at a time. It should be noted that while FIG. 3 includes RF interface type A 341a and RF interface type B 341b, NFC device 310 and/or NFC controller 340 may include any number of different NFC-specific RF interface types, such as but not limited to Type A, Type B, Type B′, and Type F.

Host controller 342 can be included in the CLF of NFC controller 340. In an aspect, host controller 342 can include one or more RF Gates 343a-343b for each RF technology supported by NFC device 310. In the illustrated example, for example, host controller 342 includes RF gate 343a to correspond to RF interface type A 341a. Similarly, host controller 342 includes RF gate 343b to correspond to RF interface type B 341b. Host controller 342 can be configured to enable communications between one or more components, such as host 320, secure element 350, and/or terminal host 344, and remote NFC device 380 using one of the selected RF gates 343a-343b and the corresponding RF interface 341-341b.

RF gates 341a-341b can be connected to an application gate 355a-355b to enable card emulation using a specified application when that application uses the enabled RF technology. For example, if application 356b is configured to communicate using RF technology type B, application 356b can use application gate 355b and RF gate 343b to use RF interface type B 341b to communicate with remote NFC device 380. In an aspect, RF manager 348 can ensure application 356b is not used until RF interface type B is enabled. In an aspect, RF gates 343a, 343b may communicate with application gates 345a, 345b using the Host Controller Interface (HCl) protocol over a single wire protocol (SWP) interface.

Terminal host 344 can be a component in NFC controller 340 that enables other components and modules to operate with one or more applications. In an aspect, host 320 can communicate with terminal host 344 using NCI 330. In an aspect, communication between host 320 and terminal host 344 may take place using the HCl protocol. Terminal host 344 can enable other components within NFC controller 340 or other components within NFC device 310 to access applications 356a and 356b. Similarly, HCE module 324, when executed by host 320, can provide applications 326a and 326b. In an aspect, applications 356a and 356b communicate with RF interface 341a or 341b using an ISO-DEP protocol over NCI 330.

In some implementations, applications 326a and 326b can be stored in memory 322 and provide instructions to NFC controller 340 and/or host 320 to operate in card emulation mode. In some aspects, an application 356a and 356b can operate with HCE module 324 to perform a card emulation operation with host 320 without the use of secure element 350. In some aspects, applications 326a, 326b, 356a, 356b can operate with host controller 342 to access certain data stored in secure element 350 to perform card emulation operations.

In an aspect, RF manager 328 can be stored in memory 322 in host 320 and RF manager 348 can be stored in a memory in NFC controller 340. In an aspect, RF manager 328 and/or 348 may have host 320 and/or NFC controller 340 retrieve stored preferred RF technologies associated with each application 326a, 326b, 356a, 356b to use for communications.

In some aspects, host 320 executing instructions provided by RF manager 328 can be configured to determine the preferences of an application 326a, 326b, 356a, 356b to determine the preferred or supported RF technology types before establishing communications with remote NFC device 380. In such instances, host 320, NFC controller 340, and/or RF manager 328, 348 can suspend attempts at communications for the application when host 320 and/or RF manager 328 determines that the enabled RF technology is not preferred and/or is not supported by the application 326a, 326b, 356a, 356b being queried.

In some aspects, NFC controller 340 executing instructions provided by RF manager 348 can be configured to determine the preferences of an application 325a, 326b, 356a, 356b to determine the preferred or supported RF technology types before establishing communications with remote NFC device 380. In such instances, NFC controller 340 and/or RF manager 348 can suspend attempts at communications for the application when NFC controller 340 and/or RF manager 348 determine that the enabled RF technology is not preferred and/or is not supported by the application 326a, 326b, 356a, 356b being queried.

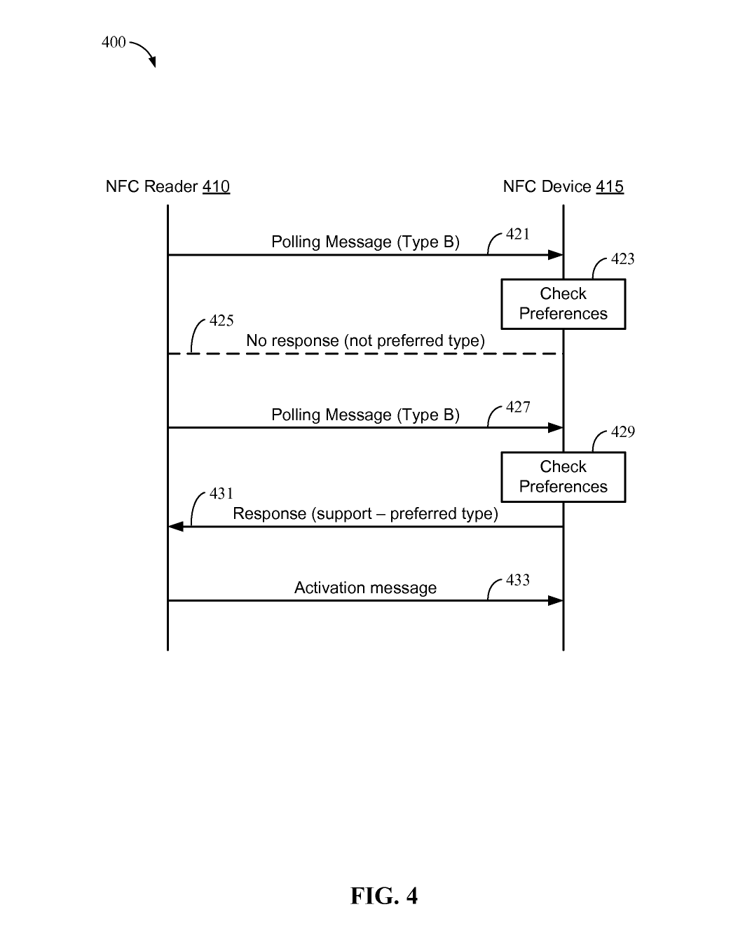

Host-based card emulation (HCE) module 324 can be stored in memory 322 in NFC device 310. In an aspect, HCE module 324 can be stored in host 320. In an aspect, HCE module 324 can provide instructions to host 320 for card emulation; in such instances, host 320 can perform card emulation operations without the use of secure element 350. In some aspects, HCE module 324, operating in conjunction with RF manager 328 and/or 348, can provide instructions to determine the RF technology type in use by NFC device 310. In some aspects, HCE module 324, operating in conjunction with RF manager 328 and/or 348, can provide instructions to determine the RF technology type being used by remote NFC device 380. As will be discussed in further detail in relation to FIG. 4, in some aspects, HCE module 324, operating in conjunction with RF manager 328 and/or 348, can provide instructions to retrieve a parameter from an RF gate entry to determine whether the RF gate is enabled.

Secure element 350 can be a device, such as a universal integrated circuit card (UICC), an embedded secure element (eSE), or a component of a memory, such a as a component of an SD or a microSD card. Secure element 350 can be used to store restricted information, including network information and secure card information. Secure element 350 can communicate with remote NFC device 380 through NFC controller 340. In an aspect, RF manager 348 can provide instructions for NFC controller 340 to determine a preferred RF type and whether to access secure element 350. In an aspect, secure element 350 can support one or more RF technologies for communication with remote NFC device 380. For example, secure element can communicate with remote NFC device 380 using RF technologies Type A, B, B′, and/or F, as defined in ISO 1443 or ISO 18092. In some aspects, an application can support communications using secure element 350 using multiple RF technologies; in such instances, host controller 342 can access secure element 350 whenever any of the supported RF technology types is enabled.

Additionally, it should be noted that while RF managers 328 and 348 are illustrated as a separate component within memory 322 of host 320 and a module in NFC controller 340, RF managers 328 and/or 348 may be implemented within any one or any combination of host 320, NFC controller 340, host controller 342, terminal host 344, and host-based card emulation (HCE) module 324, or in any component in communication with one or more of these components.

FIG. 4 is a signaling diagram of an NFC environment in accordance with an aspect of the present disclosure. Communications illustrated in diagram 400 between an NFC reader 410 and an NFC device 415 can occur, for example, when NFC Device 415 includes multiple supported RF technologies. In an aspect, NFC reader 410 may be the same as or similar to remote NFC device 380, NFC Device 415 may be the same as or similar to NFC device 310, including RF managers 328 and/or 348 performing the functions described herein to ensure use of a preferred NFC-type communication technology. An application included in NFC Device 415 may support communications using only a subset of RF technologies supported by NFC Device 415; in such instances, NFC Device 415 can suspend signaling to support communications until NFC reader 410 sends a signal on the supported RF technology.

NFC reader 410 can send a polling message 421 to NFC Device 415. In the illustrated aspect, for example, NFC reader 410 can send a type B polling message to NFC Device 415. In some aspects, NFC reader 410 sends polling message 421 using one of the RF modulation techniques. In the illustrative aspect, for example, polling message 421 can be sent to NFC Device 415 using RF modulation techniques associated with RF technology type B. In some aspect, NFC reader 410 may, in alternating intervals, send a polling message using one RF modulation technique and then another modulation technique. In some aspects, NFC controller 410 can parse polling message 421 to retrieve the RF technology type information from the incoming polling message 421.

In an aspect, NFC Device 415 and/or RF manager 328, 348 can determine the RF technology based on the RF interface that was enabled at the time polling message 421 was received. In such instances, NFC Device 415 and/or RF manager 328, 348 can retrieve a parameter (e.g., a MODE parameter) from an entry in a register associated with an RF gate. NFC Device 415 and/or RF manager 328, 348 can retrieve register entries for each of the RF gates to determine which gate was enabled at the time the message was received. The active RF gate can indicate the RF technology type. For example, NFC Device 415 and/or RF manager 328, 348 can retrieve a MODE parameter entry for RF interface type A to determine that it was enabled when NFC Device 415 received polling message 421. NFC Device 415 and/or RF manager 328, 348 can use this information to determine that the RF technology is RF technology type A.

At block 423, NFC Device 415 and/or RF manager 328, 348 can check preferences to determine if an application supports communications using the RF technology specified in polling message 421. In the illustrative aspect, for example, NFC Device 415 and/or RF manager 328, 348 can check preferences of applications in the terminal host 320 and/or the secure element 350 to determine if an application supports communications using RF technology type B.

When the queried application does not support the RF technology associated with polling message 421, NFC Device 415 and/or RF manager 328, 348 ignore the polling message, e.g., by not responding, as specified by the no response message 425. In the illustrative aspect, for example, the queried application did not specify RF technology type B as a preferred or supported RF technology. NFC Device 415 and/or RF manager 328, 348 in turn provides no response to NFC reader 410 after receiving polling message 421.

NFC reader 410 can later send another polling message 427. As noted, in some aspects, NFC reader 410 can alternate polling messages associated with different RF technologies. For example, NFC reader 410 can alternate between polling messages for Type A and polling messages for Type B on a 75% duty cycle. Other period switches between the frequency of polling messages for RF technologies Type A and Type B can also be achieved.

At block 429, NFC Device 415 and/or RF manager 328, 348 can, in a similar fashion to the step at 423, check preferences to determine if an application supports communications using the RF technology specified in polling message 427. In the illustrative aspect, for example, NFC Device 415 and/or RF manager 328, 348 checks the preferences of applications in HCE module 324 of terminal host 320 or in secure element 350 to determine if an application supports communications using RF technology type A. In the illustrative aspect, for example, NFC Device 415 and/or RF manager 328, 348 determines that the queried application has preferences to support RF technology Type A. In an aspect, NFC Device 415 and/or RF manager 328, 348 can also enable RF interface type A.

NFC Device 415 and/or RF manager 328, 348 can send a response message 431 to NFC reader 410 in response to polling message 427. NFC Device 415 and/or RF manager 328, 348 can send response message 431 when NFC Device 415 and/or RF manager 328, 348 determines that the RF technology associated with polling message 427 is the preferred or supported RF technology type. NFC Device 415 and/or RF manager 328, 348 can send response message 431 to establish communications between NFC device 415 and NFC reader 410. NFC reader 410 can in turn send activation message 433 to establish NFC communications between NFC reader 410 and NFC device 415.

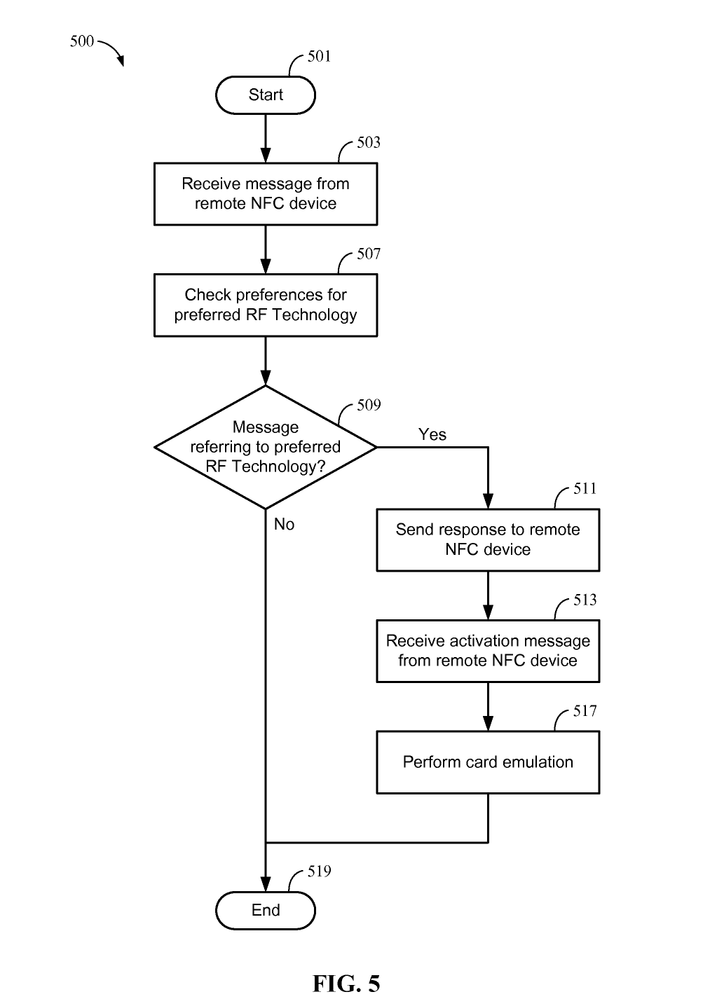

FIG. 5 is a flowchart describing an aspect of card emulation in accordance with an aspect of the present disclosure. An NFC device like NFC host device 310 and/or NFC Device 415 including RF manager 328, 348 can perform method 500 to when attempting to perform a card emulation operation with a remote NFC device.

Method 500 can begin at 501 and proceed to 503, where NFC device 310 receives a message from remote NFC device 380. In some aspects, NFC device 310 can receive a polling message 421, 427 that specifies an RF technology to use when establishing communications.

At 507, once NFC device 310 receives the message from the remote NFC device 380, NFC device 310 and/or RF manager 328, 348 can check preferences for a preferred RF technology. In some aspects, NFC device 310 and/or RF manager 328, 348 can check information stored in memory 322 and associated with one or more applications to determine whether the RF technology specified by the received message is the preferred RF technology to establish NFC communications. In some aspects, an application can be associated with multiple RF technologies that are preferred or supported.

At 509, NFC device 310 and/or RF manager 328, 348 can determine whether the message received from remote NFC device 380 refers to a preferred RF technology. RF manager 328, 348 in NFC device 310 can compare the retrieved preference of RF technology and determine whether this matches the specified RF technology of the polling message received from remote NFC device 380. When the RF technologies do not match, NFC device 310 and/or RF manager 328, 348 ends method 500 at step 519. In other words, at 519, NFC device 310 and/or RF manager 328, 348 do not respond to the polling message. When the RF technologies match, NFC device 310 and/or RF manager 328, 348 can proceed to 511.

At 511, NFC device 310 and/or RF manager 328, 348 can send a response message 431 to establish NFC communications with remote NFC device 380 using the RF technology specified in the received polling message. NFC device 310 can then wait and, at 513, receive an activation message 433 from remote NFC device 380 to establish NFC communications for card emulation operations.

NFC device 310 at 517 can perform card emulation operations with remote NFC device 380. In an aspect, host 320 and/or NFC controller 340 of NFC device 310 uses instructions provided by the queried application to perform card emulation operations. In some aspects, NFC device 310 uses information retrieved from secure element 350 to perform the card emulation operation. In some aspects, host 320 or NFC controller 340 uses instructions provided by HCE module 324 to perform the card emulation operation without accessing secure element 350. Once the card emulation operation is complete, NFC device 310 can complete method 500 at 519.

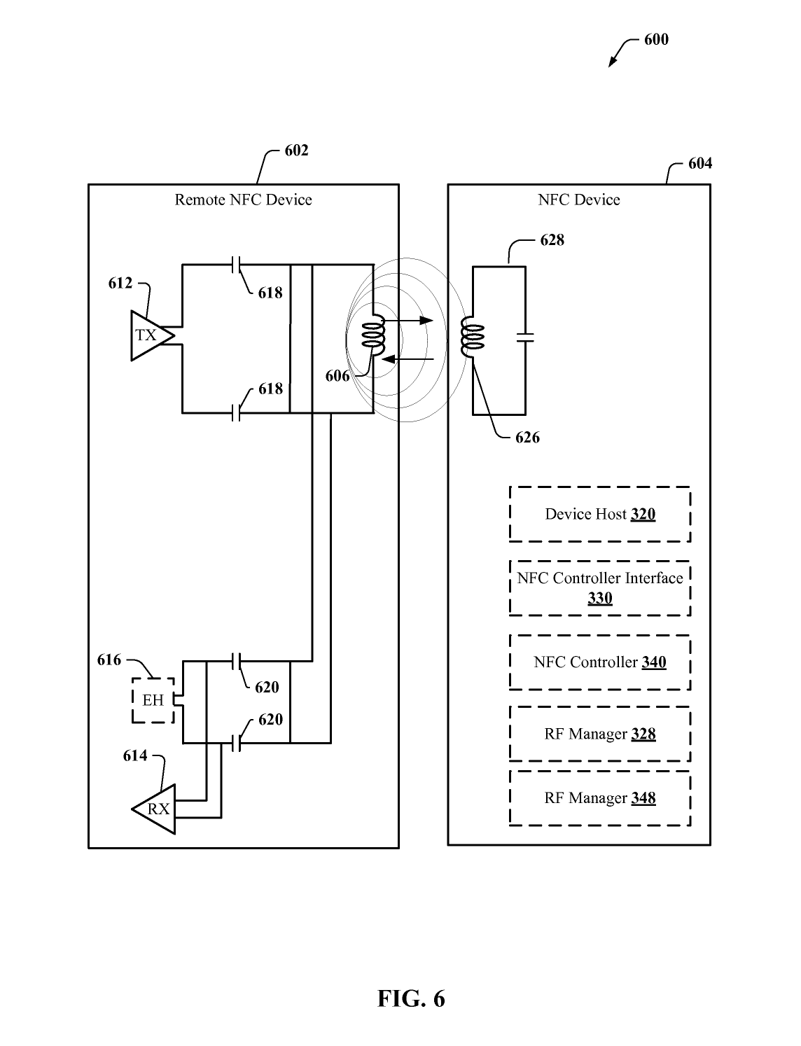

FIG. 6 illustrates a block diagram of an exemplary communication network 600 including a remote NFC device 602 and an NFC device 604 configured to include RF manager 348 as described herein. Remote NFC device 602 can include an NFC antenna coil 606 configured to facilitate NFC communications with NFC device 604, which can have a similar NFC coil 626. Remote NFC device 602 can be the same as or similar to remote NFC device 380 (see FIG. 3), which may be operating as a reader type NFC device. NFC device 604 can be the same as or similar to NFC device 310 (see FIG. 3), which can be operating in a card emulation mode. Further, for example, NFC device 604 can include host 320 (FIG. 3), NFC controller interface 330 (FIG. 3), and NFC controller 340 (FIG. 3), and RF manager 348 (see FIG. 3), as described herein.

As part of NFC communications, NFC antenna coil 606 can generate an electro-magnetic field in the area around NFC antenna coil 606. The strength of the field may depend on the power source and the size and number of turns in NFC antenna coil 606. Further, impedance mismatches can cause a range of amplitude/phase changes dependant on size and inductance of NFC antenna coil 606 in magnetic field 628. Capacitor 618 can be connected in parallel with NFC antenna coil 606, where a transmitter component 612 and capacitors 618 can form an RLC oscillator establishing a resonant circuit with a frequency that corresponds to one or more transmission frequencies of NFC device 602.

Because the wavelength of the frequency used is several times greater than the close proximity distance between NFC antenna coil 606 and antenna coil 626 of NFC device 604, the electromagnetic field can be treated as an alternating magnetic field 628. This region of close proximity is referred to as the “near-field region”. Remote NFC device 602 and NFC device 604 can be linked by their mutual inductance, as in an air core transformer, with the primary coil being NFC antenna coil 606 and the secondary coil being antenna coil 626 of NFC device 604. Alternating magnetic field 628 penetrates antenna coil 626 of NFC device 604 when it is in the near-field region, inducing an alternating current in antenna coil 626 of NFC device 604.

When operating in a listening mode, NFC antenna coil 606, capacitors 620, optional energy harvester (EH) 616, and a receiver component 614 may form an RLC oscillator establishing a resonant circuit over which modulation of signal by NFC device 604 can be detected. When operating in a transmitting mode, remote NFC device 602 can apply a variable load resistance to NFC antenna coil 606, thereby modulating magnetic field 628, to send a transmitted signal to transfer data to NFC device 604.

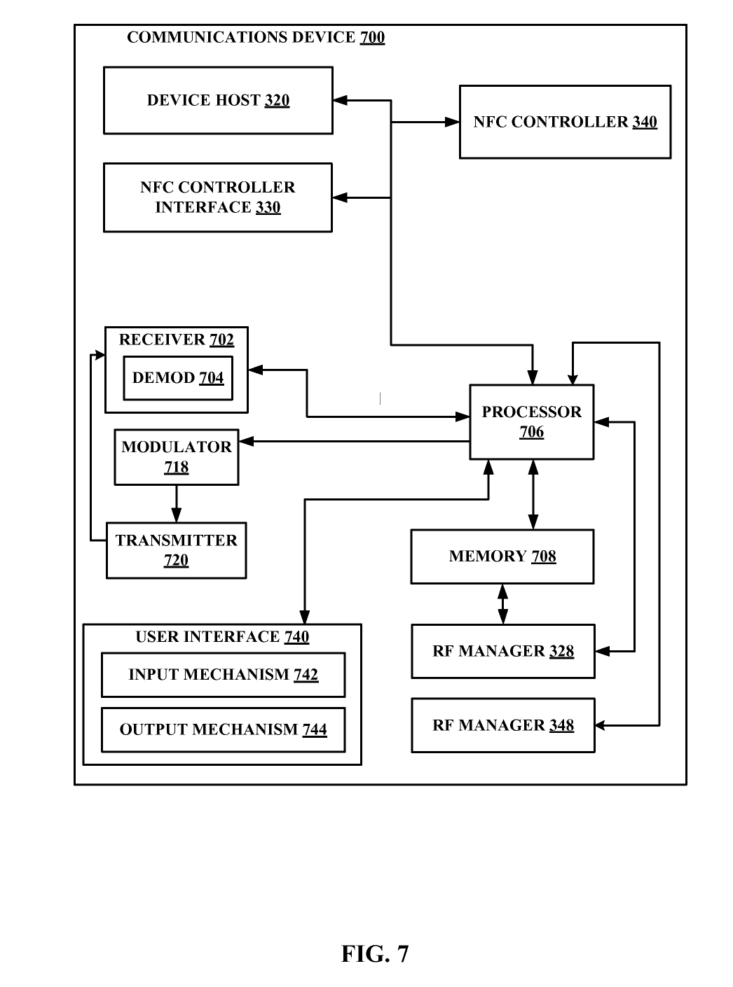

FIG. 7 illustrates an exemplary architecture of a communications device 700 that may include or be the same as or similar to NFC device 310, including RF manager 348 (see FIG. 3) as described herein. Communications device 700 may thus include components thereof and/or perform the associated functions described above.

As depicted in FIG. 7, communications device 700 can include receiver 702, which receives a signal from, for instance, a receive antenna, performs typical actions on (e.g., filters, amplifies, down-converts, etc.) the received signal, and digitizes the conditioned signal to obtain samples. Receiver 702 can include a demodulator 704 that can demodulate received symbols and provide them to processor 706 for channel estimation.

Processor 706 can be a processor dedicated to analyzing information received by receiver 702 and/or generating information for transmission by transmitter 720, a processor that controls one or more components of communications device 700, and/or a processor that both analyzes information received by receiver 702, generates information for transmission by transmitter 720, and controls one or more components of communications device 700. Further, signals can be prepared for transmission by transmitter 720 through modulator 718, which can modulate the signals processed by processor 706.

Communications device 700 can additionally include memory 708 that is operatively coupled to processor 706 and that can store data to be transmitted, received data, information related to available channels, TCP flows, data associated with analyzed signal and/or interference strength, information related to an assigned channel, power, rate, or the like, and any other suitable information for estimating a channel and communicating via the channel.

Further, transmitter 720 can generate a transmission signal for a transmitted carrier at a transmit circuit, and receiver 702 can receive a received carrier at a receive circuit. As described, transmitter 720 can be looped back to receiver 702 so the receiver 702 can receive the unmodulated carrier.

Processor 706 can include or can implement RF manager 348 (see FIG. 3), as described herein.

It will be appreciated that data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 608 of the subject systems and methods can comprise, without being limited to, these and any other suitable types of memory. For example, memory 608 can include instructions for performing the functions of the various components described herein.

Communications device 700 can include NFC controller interface (NCI) 330. In an aspect, NCI 330 can be configured to enable communications between NFC controller 340 and device host 320 and/or RF manager 348 (see FIG. 3), as described herein. Additionally, communications device 700 can include user interface 740. User interface 740 can include input mechanisms 742 for generating inputs into communications device 700, and output mechanism 744 for generating information for consumption by the user of the communications device 700. For example, input mechanism 742 can include a mechanism such as a key or keyboard, a mouse, a touch-screen display, a microphone, etc. Further, for example, output mechanism 744 can include a display, an audio speaker, a haptic feedback mechanism, etc. In the illustrated aspects, output mechanism 744 can include a display configured to present media content that is in image or video format or an audio speaker to present media content that is in an audio format.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station (STA), mobile, mobile device, remote station, mobile equipment (ME), remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH, near-field communications (NFC-A, NFC-B, NFC-F, etc.), and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules configured to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer-storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrated aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

1. A method of near-field communication (NFC), the method comprising:
receiving, at an NFC controller, a message from a remote NFC device specifying a radio frequency (RF) technology for communication;
determining whether the specified RF technology matches a preferred RF technology for an application; and
establishing, by the NFC controller, NFC communications with the remote NFC device only when the specified RF technology matches the preferred RF technology of the application, wherein the NFC communications are established using the specified RF technology.

2. The method of claim 1, wherein establishing the NFC communications further comprises:
performing, by the NFC controller, a card emulation operation.

3. The method of claim 2, further comprising:
accessing, by the NFC controller, a secure element, wherein the secure element is accessed for the NFC card emulation operation.

4. The method of claim 2, wherein the card emulation operation comprises a host-based card emulation (HCE).

5. The method of claim 1, further comprising:
determining, by the NFC controller, the specified RF technology for communication.

6. The method of claim 5, wherein the NFC controller determining the specified RF technology further comprises:
retrieving a parameter from a plurality of registry entries associated with an RF gate; and
determining the value of the parameter, wherein the value of the parameter indicates whether the RF gate is enabled.

7. The method of claim 1, further comprising:
receiving a input identifying the preferred RF technology for the application; and
storing, by the NFC controller, the preferred RF technology in association with the application.

8. The method of claim 1, wherein the preferred RF technology is a technology selected from a group consisting of:
Type A, Type B, Type B′, and Type F.

9. An apparatus for controlling near-field communication (NFC), comprising:
means for receiving a message from a remote NFC device specifying a radio frequency (RF) technology for communication;
means for determining whether the specified RF technology matches a preferred RF technology for an application; and
means for establishing NFC communications with the remote NFC device only when the specified RF technology matches the preferred RF technology of the application, wherein the NFC communications are established using the specified RF technology.

10. The apparatus of claim 9, wherein the means for establishing NFC communications further comprises:
means for performing, by the NFC controller, a card emulation operation.

11. The apparatus of claim 10, further comprising:
means for accessing a secure element, wherein the secure element is accessed for the NFC card emulation operation.

12. The apparatus of claim 10, wherein the card emulation operation comprises a host-based card emulation (HCE).

13. The apparatus of claim 9, further comprising:
means for determining the specified RF technology for communication.

14. The apparatus of claim 13, wherein the means for determining the specified RF technology further comprises:
means for retrieving a parameter from a plurality of registry entries associated with an RF gate; and
means for determining the value of the parameter, wherein the value of the parameter indicates whether the RF gate is enabled.

15. The apparatus of claim 9, further comprising:
means for receiving a input identifying the preferred RF technology for the application; and
means for storing the preferred RF technology in association with the application.

16. The apparatus of claim 9, wherein the preferred RF technology is a technology selected from a group consisting of:
Type A, Type B, Type B′, and Type F.

17. A non-transitory computer-readable medium storing computer-executable code for controlling near-field communication (NFC), comprising:
code for receiving a message from a remote NFC device specifying a radio frequency (RF) technology for communication;
code for determining whether the specified RF technology matches a preferred RF technology for an application; and
code for establishing NFC communications with the remote NFC device only when the specified RF technology matches the preferred RF technology of the application, wherein the NFC communications are established using the specified RF technology.

18. The computer-readable medium of claim 17, wherein the code for establishing NFC communications further comprises:
code for performing a card emulation operation.

19. The computer-readable medium of claim 18, further comprising:
code for accessing a secure element, wherein the secure element is accessed for the NFC card emulation operation.

20. The computer-readable medium of claim 18, wherein the code for performing a card emulation operation comprises code for a host-based card emulation (HCE).

21. The computer-readable medium of claim 17, further comprising:
code for determining the specified RF technology for communication, comprising:
code for retrieving a parameter from a plurality of registry entries associated with an RF gate; and
code for determining the value of the parameter, wherein the value of the parameter indicates whether the RF gate is enabled.

22. The computer-readable medium of claim 17, further comprising:
code for receiving a input identifying the preferred RF technology for the application; and
code for storing the preferred RF technology in association with the application.

23. The computer-readable medium of claim 17, wherein the preferred RF technology is a technology selected from a group consisting of:
Type A, Type B, Type B′, and Type F.

24. An apparatus for near-field communication (NFC), comprising:
an NFC controller configured to:
receive a message from a remote NFC device specifying a radio frequency (RF) technology for communication;
determine whether the specified RF technology matches a preferred RF technology for an application; and
establish NFC communications with the remote NFC device only when the specified RF technology matches the preferred RF technology of the application, wherein the NFC communications are established using the specified RF technology.

25. The apparatus of claim 24, wherein to establish the NFC communications the NFC controller is further configured to:
perform a card emulation operation.

26. The apparatus of claim 25, wherein the NFC controller is further configured to:
access a secure element, wherein the secure element is accessed for the NFC card emulation operation.

27. The apparatus of claim 25, wherein the card emulation operation comprises a host-based card emulation (HCE).

28. The apparatus of claim 24, wherein the NFC controller is further configured to:
determine the specified RF technology for communication, by:
retrieving a parameter from a plurality of registry entries associated with an RF gate, and
determining the value of the parameter, wherein the value of the parameter indicates whether the RF gate is enabled.

29. The apparatus of claim 24, wherein the NFC controller is further configured to:
receive a input identifying the preferred RF technology for the application; and
store the preferred RF technology in association with the application.

30. The apparatus of claim 24, wherein the preferred RF technology is a technology selected from a group consisting of:
Type A, Type B, Type B′, and Type F.
